(19) United States
(12) Patent Application Publication
(10) Pub. No.: US 2025/0128846 A1
(43) Pub. Date: Apr. 24, 2025

(54) MANIPULATOR OF ARTICLES IN BOXES AND RELATED PROCESS FOR MOVING ARTICLES IN BOXES

(71) Applicant: R.A JONES & CO., Covington, KY (US)

(72) Inventors: Gianluca PARISINI, Bologna (IT); Cristian DAKESSIAN, Bologna (IT)

(73) Assignee: R.A JONES & CO., Covington, KY (US)

(21) Appl. No.: 18/754,200

(22) Filed: Jun. 26, 2024

(30) Foreign Application Priority Data
Jun. 28, 2023 (IT) 102023000013449

(51) Int. Cl. B65B 43/46; B65B 5/04; B65B 43/26; B65B 43/52; B65G 47/91

(52) U.S. Cl. CPC B65B 43/46; B65B 5/04; B65B 43/265; B65B 43/52; B65G 47/915

(57) ABSTRACT

A manipulator of articles in boxes, moved along a path with at least one curvilinear section, includes a pair of gripping elements cooperating with each other to grasp one of the boxes and a containment element in a radially external position with respect to the curvilinear section. The manipulator is movable from an open configuration to a gripping configuration and vice versa, pivoting the gripping elements and the containment element along a first movement trajectory and a second movement trajectory, respectively. The containment element is configured so as to at least partially obstruct the opening when the gripping elements grasp a respective box to move it along the curvilinear section, so as to prevent the articles from escaping the box.

### CROSS-REFERENCE TO RELATED APPLICATIONS

This application claims benefit of Italian Patent Application No. 10202300013449, filed Jun. 28, 2023, the entire contents of which are incorporated by reference herein as if fully set forth.

### FIELD OF THE INVENTION

The present invention relates to a manipulator of articles in boxes and a related packaging apparatus. It is also related to a related process for moving articles in boxes.

### BACKGROUND

The content of the Italian patent application No. 102021000032927, filed on 29 Dec. 2021 by the same Applicant, entitled “Process for moving packages and manipulator for packages provided to operate according to this process” is considered fully incorporated herein.

The contents of Italian patent application No. 102021000029750, filed on 24 Nov. 2021 by the same Applicant, entitled “Method for packaging articles in boxes and packaging device operating according to such a method” is considered fully incorporated herein.

The present invention has a preferred, though not exclusive, application in the field of forming packages with a box-like body, for the sake of simplicity also called packages or boxes, for boxing articles with variable geometry, in turn containing products, which may be food items or otherwise. An example of products with variable geometry is sachets of cereal, e.g. oat flakes or puffed rice, which can be referred to later without loss of generality.

In particular, in this technical sector, devices are known for packaging articles in boxes, based mainly on the use of conveyor belts, in which the boxing step is carried out by means of an element which pushes the product, e.g. a cereal sachet, inside a package with a box-like body, also definable as a pre-formed rigid box, comprising one or more openings through which the sachet is inserted and which is closed by means of folding devices arranged along the conveyor belts.

Alternatively, some systems envisage boxing the article with variable geometry by depositing it in a mandrel and wrapping a cardboard blank around the mandrel itself so as to form the box-like body of the package (known as the “wrap-around” process).

Typically, in cereal sachet packaging equipment, the cereal sachets are moved on linear conveyor belts and, if necessary, they pass from one belt to another by gravity. Furthermore, the transport of the sachet inside the box and the closing of the box takes place along linear conveyor belts, equipped with folding and gluing devices at their side ends.

### Definitions

In the present description as well as in the accompanying claims, some terms and expressions are deemed to have, unless otherwise expressly indicated, the meaning expressed in the following definitions.

A product is said to have “variable geometry” when, due to the nature of the material it contains, the product does not have a defined shape. In particular, the product may be a sachet or bag containing loose material, e.g. granular material or flakes or powder, or material in liquid form.

The term “adhesion element” referring to a manipulator means a retaining element capable of retaining an object by contact, specifically it can be suction cups or magnets, Velcro and/or surfaces coated with temporary glues.

“Box” or “package” means any container adapted to contain a plurality of articles for the purpose of their packaging, which can be made starting from a blank by folding around a mandrel and subsequent fixing at edges or panels thereof.

The term “article” means any product which can be packaged in boxes.

“Packaging” one or more articles in a box means obtaining a box containing said one or more articles. Such packaging can be obtained by inserting one or more articles into an already formed box or, preferably, it can be obtained by forming a box around the one or more articles to be contained.

“Mandrel” means a container capable, on the one hand, of accommodating and supporting the article to be packaged and, on the other hand, of providing an effective abutment for folding the blank when wrapped around it.

For this purpose, it should be noted that accommodating and supporting the article does not in itself imply that the article must be entirely accommodated inside the mandrel or completely supported by it, but it is sufficient for it to be accommodated in the moment in which the blank is wrapped around the mandrel.

Likewise, it should be noted that also the abutment of the blank does not imply in itself that the blank is abutted for its entire surface by the mandrel, but it is sufficient for it to be abutted to an extent such as to allow the correct folding necessary for the formation of the box.

“Vertical” or “vertically” refers to a direction parallel to the direction defined by the force of gravity or deviating from the direction defined by the force of gravity by a maximum of 10°; “lowering” refers to a vertical displacement with a direction concordant to gravity, “lifting” refers to a vertical displacement with a direction discordant to gravity.

“Horizontal” or “horizontally” means a direction belonging to a plane perpendicular to the direction of the force of gravity.

“Gripping configuration” means a closed configuration of gripping elements, in which the gripping elements are brought closer together so that a box can be grasped.

“Open configuration” refers to a configuration in which the gripping elements are spaced apart with respect the gripping configuration so that a box cannot be grasped.

### SUMMARY

The Applicant first noted that the movement of articles in boxes which are not yet closed at their longitudinal ends can be a critical factor in the packaging process. In fact, in this configuration, the article is potentially capable of escaping from the open box and this unwanted event could cause serious damage to the article and even stop production.

In particular, the Applicant verified that such an eventuality becomes highly probable whenever the movement of the box involves a curvilinear trajectory, where the product's escape from the box may be favored by the action of the centrifugal force.

The Applicant also verified that in high-capacity boxing processes, the use of rotary type transfer devices is preferred, which can operate continuously, advantageously preventing mechanical complications and slowdowns due to the acceleration and deceleration phases of discontinuous type transfer devices. Usually, transfer devices of the rotating type are called carousels.

The Applicant noted, however, that the movement of articles in boxes which are still open, carried out by gripper-type manipulators mounted on a carousel, can result in the article contained therein escaping, particularly when high production speeds are required.

The Applicant has therefore realized that the escape of articles from the boxes during the movement stop of the boxes also along a curved trajectory, without placing substantial limitations on the movement speed, can be prevented by providing on the manipulator itself one or more containment elements suitable for retaining the article inside the box, counteracting the centrifugal force to which it is subjected.

The Applicant finally found that the manipulator of articles in boxes which have not yet been closed could be optimized by equipping it with at least one containment element capable of acting in a radially external position with respect to a curvilinear section of a predefined movement path.

Such a solution makes it possible to move said articles in boxes between two conveyor belts or generally between a starting point and an arrival point, avoiding dropping an article contained in said box when it is not yet fully closed.

Therefore, in a first aspect thereof, the present invention relates to a manipulator of articles in boxes.

Preferably, the manipulator is moved along a predefined path comprising at least one curvilinear section.

Preferably, such boxes have a box-like body extended longitudinally between a front end and a rear end.

Preferably, said box-like body has an opening at at least one of said front end and rear end.

Preferably, said front end is radially external with respect to said curvilinear section.

Preferably, said rear end is radially internal with respect to said curvilinear section.

Preferably, said manipulator comprises a pair of gripping elements cooperating with each other to grasp one of said packages.

Preferably, said manipulator comprises a containment element suitable for retaining an article in one of said boxes.

Preferably, said containment element is located in a radially external position with respect to the curvilinear section.

Preferably, the manipulator is movable from an open configuration to a gripping configuration and vice versa.

Preferably, the gripping elements are pivotable along a first movement trajectory between said open configuration and said gripping configuration and vice versa.

Preferably, the containment element is pivotable along a second movement trajectory between said open configuration and said gripping configuration and vice versa.

Preferably, the containment element is configured so as to at least partially obstruct said opening when the gripping elements grasp a respective box in order to move it along said curvilinear section, and so as to prevent said articles from escaping.

Thanks to such features, it is possible to move boxes containing an article even on curvilinear trajectories without any particular speed limitations, minimizing damage to the articles contained and minimizing the boxes being discarded or lost during movement.

In a second aspect thereof, the present invention relates to a packaging apparatus for packaging articles in boxes.

Preferably, said apparatus comprises a manipulator for boxes according to the first aspect.

Preferably, said apparatus comprises a mandrel configured to accommodate one of said articles therein, around which a box is arranged.

Preferably, said apparatus is configured so that said manipulator is arranged to take said box from said mandrel and move it along a predefined path comprising at least one curvilinear section.

Preferably, the containment element is configured so as to partially enter said box to retain said article preferably when the manipulator moves the box along said curvilinear section.

Preferably, in said apparatus, said manipulator is mounted on a carousel.

In a third aspect, the present invention relates to a first embodiment of a process for moving articles in boxes.

Preferably, said articles in boxes are moved along a predefined path comprising at least one curvilinear section.

Preferably, such boxes have a box-like body extended longitudinally between a front end and a rear end.

Preferably, said box-like body has an opening at at least one of said front end and rear end.

Preferably, said opening is at at least one of said ends which is radially external with respect to said curvilinear section.

Preferably, said process comprises the step of providing a manipulator on which a pair of gripping elements and a containment element are mounted in an open configuration.

Preferably, said process comprises the step of gripping one of said boxes via said manipulator by pivoting the gripping elements into a gripping configuration.

Preferably, said process comprises the step of at least partially obstructing said opening with the containment element, so as to contain said article inside the box at least in said curvilinear section, making the containment element pivot in a gripping configuration.

Preferably, said process comprises the step of moving said box by displacing said manipulator along said predefined path.

Preferably, said process comprises the step of releasing said box.

In a fourth aspect, the present invention relates to a second embodiment of a process for moving articles in boxes.

Preferably, said articles in boxes are moved along a predefined path comprising at least one curvilinear section.

Preferably, such boxes have a box-like body extended longitudinally between a front end and a rear end.

Preferably, said box-like body has an opening at at least one of said front end and rear end.

Preferably, said opening is at at least one of said ends which is radially external with respect to said curvilinear section.

Preferably, said process comprises the step of depositing at least one article inside a mandrel.

Preferably, said process comprises the step of arranging an at least partially closed box around said article deposited in said mandrel.

Preferably, said process comprises the step of leaving said article positioned inside said box.

Preferably, said process comprises the step of providing a manipulator on which a pair of gripping elements and a containment element are mounted in an open configuration.

Preferably, said process comprises the step of gripping one of said boxes via said manipulator by pivoting the gripping elements into a gripping configuration.

Preferably, said process comprises the step of at least partially obstructing said opening with the containment element, so as to contain said article inside the box at least in said curvilinear section by pivoting the containment element in a gripping configuration.

Preferably, said process comprises the step of moving said box by displacing said manipulator along said predefined path.

Preferably, said process comprises the step of releasing said box.

In at least one of the above aspects, the present invention may also have at least one of the preferred features set out hereinafter.

In some embodiments, said gripping elements pivot about first axes of rotation parallel to each other and said containment element pivots about a second axis of rotation substantially perpendicular to said first axes of rotation.

Preferably, the pivoting of said gripping elements about the first axes of rotation occurs substantially simultaneously with the pivoting of said containment element about said second axis of rotation.

Preferably, said containment element is configured so as to at least partially obstruct said opening.

Thereby, the action of grasping the box and obstructing the opening can occur simultaneously, reducing the boxing and movement time, and preventing the articles contained in the box from escaping, even at high production speeds of the apparatus.

Alternatively, the pivoting of said gripping elements about the first axes of rotation occurs before the pivoting of said containment element about said second axis of rotation.

The containment element can comprise a head, a bar or other abutment element.

Preferably, said manipulator moves said articles in boxes from a starting point to an arrival point along said predefined path with at least one curvilinear section.

Preferably, a plurality of adhesion elements is interposed between said gripping elements.

Preferably, each of said gripping elements comprises a main body extended longitudinally between a first end region and a second end region.

Preferably, a plurality of prongs extends from said main body, said prongs being configured to abut said box when grasped by said gripping elements.

Preferably, said prongs are substantially perpendicular to said movement trajectory.

Preferably, said prongs are movable along the main body, e.g. along said longitudinal extension of the main body.

Thereby, the dimensions of the gripping elements can be adjusted according to the longitudinal extension of the box to be moved.

Preferably, said box is moved by said manipulator substantially within a geometric plane.

Thereby, it is the manipulator that changes its position according to the geometric plane on which said box is to move, so that the box is moved as smoothly and evenly as possible.

Preferably, said geometric plane is a horizontal geometric plane.

Preferably, said curvilinear section is an arc of a circle.

In some embodiments, said box is released by separating it from the adhesion elements and opening the gripping elements and the containment element.

Preferably, the separation of the adhesion elements from the box and the opening of the gripping elements take place simultaneously.

Thereby, the substantial simultaneity of the two actions allows high production speeds to be maintained, minimizing movement times.

Thereby, at high production speeds and/or predefined curvilinear paths, the adhesion elements hold the box during its movement by the manipulator, preventing said box from escaping from the gripping elements, causing the box and the article to be rejected or, worse, a momentary production stop.

Furthermore, the combined action of the adhesion elements and the gripping elements allows for a more secure retention of the box than the presence of the adhesion elements alone, and this aspect is more relevant in the case of articles of a granular nature that may generate dust that could compromise the proper retention of the adhesion elements.

In some embodiments, the adhesion elements are one of suction cups, magnetic elements, Velcro or a combination thereof, more preferably suction cups.

Preferably, said suction cups are adhered to said box, depressurizing it through a suction circuit.

Preferably, said suction cup circuit comprises a pump and a control unit.

Alternatively, said suction cup circuit comprises a Venturi effect generator and a control unit.

Preferably said control unit is a solenoid valve.

This allows the suction cups to be easily activated and deactivated, controlling the suction flow.

Preferably, said manipulator also comprises two rotational actuators, each connected to a respective gripping element.

According to some embodiments, said rotational actuators, in addition to being free to rotate each about an axis of rotation thereof, can also be displaced horizontally depending on the transverse dimension of the box to be grasped.

Preferably, said box contains an article.

Preferably, said article is an article with variable geometry.

Preferably, said apparatus comprises a first carousel rotating about a vertical axis, on which a plurality of manipulators is mounted.

Preferably, said plurality of manipulators is connected to said carousel through respective electromechanical arms.

Preferably, each arm in turn comprises a first end connected to the carousel and a second end connected to the manipulator.

Preferably, said arm comprises an actuating mechanism for each gripping element.

Preferably, the actuation mechanism in turn comprises a plurality of articulated levers which allow the gripping elements to pivot between said open configuration and said gripping configuration and vice versa.

Preferably, said apparatus comprises a second carousel rotating about a vertical axis, on which a plurality of mandrels is mounted.

In some embodiments, one of said articles is arranged in a mandrel, allowing a box to be arranged around the article. Preferably, said box is made around said article starting from a blank by folding around said mandrel.

Preferably, said packaging apparatus is configured so that said manipulator is arranged to take said box from said mandrel and move it along a predefined path comprising at least one curvilinear section. Preferably, the containment element is configured so as to partially enter said box to retain said article when the manipulator moves the box along said predefined path, more preferably along said curvilinear section.

In some embodiments, said mandrel in turn comprises at least one respective positioning element.

Preferably, said positioning element is arranged to retain the article inside the box when said article and said box are arranged on said mandrel.

Preferably, said containment element is configured so as to take over retaining said article in place of said positioning element when the gripping elements grasp said box.

Preferably, the containment element comprises an abutment wall extended transversally to the longitudinal extension of the box.

Preferably, the containment element comprises an abutment wall extended parallel to the first movement trajectory.

Preferably, the containment element and the positioning element are mutually configured to allow the containment element to be arranged inside the box before the positioning element has exited the box.

Preferably, the containment element comprises a first recess extending from the abutment wall to an attachment body thereof, to allow the containment element to pivot without interfering with the positioning element.

Similarly, preferably the positioning element comprises a front element comprising a second recess.

Preferably, said first and second recess are positioned in a complementary manner, e.g. the first recess is at the solid parts of the frontal element, the second recess is at the solid parts of the abutment wall, so as to avoid collisions between the containment element and the positioning element during the production process.

Furthermore, the containment element comprises a connection element which rotatingly connects it to the manipulator through a first hinge.

Preferably, the connection element has an elbow configuration, and at the elbow it has a second hinge to which an actuating rod of the containment element is connected.

Preferably, the actuating rod comprises a first end articulated to the connection element and a second end thereof articulated to one of the articulated levers of the electromechanical arm.

Therefore, said actuating rod can be moved together with the gripping elements and the containment element is preferably pivotably connected, by means of the actuating rod, to the articulated levers of said electromechanical arms.

Preferably, said box is picked up by said manipulator by displacing said gripping elements and said containment element in a gripping configuration.

In some embodiments, said mandrel comprises two separate units, capable of accommodating an article therein and abutting a blank during the formation of the closed box.

Preferably, following the formation of the box around said mandrel, the latter breaks down into the starting units along a separation direction, allowing to obtain several advantages, including that of being able to more easily extract such units from the box.

Preferably, said units pass from an operating position, in which the two units are partially contained inside the box, to a non-operating position, in which the two units slide out of said box, displacing along said separation direction.

Preferably, at least one of said units is associated with a positioning element, movable with respect to said unit, and arranged to retain said article within said box when said unit is extracted from said box.

The positioning element can comprise a head, bar or other abutment element, preferably extending transversely to the separation direction of the unit.

The head can be moved with respect to the unit by pivoting, or more preferably by means of translation, e.g., by means of a connection rod extended parallel to the separation direction of the unit.

Preferably, said connection rod connects the front element to each respective unit.

In some embodiments, said apparatus comprises at least one conveyor belt.

Preferably, said box is released from said manipulator onto said conveyor belt.

Preferably, said box is released from said manipulator with a predefined conformation on said conveyor belt.

Preferably, said conveyor belt comprises separator elements.

Preferably, said separator elements are designed to keep said box in said predefined conformation.

Preferably, said gripping elements are shaped so as not to interfere with said separator elements of said conveyor belt.

Thereby, the release of the box takes place close to the conveyor belt, even at high speeds, keeping the box in the conformation conferred by the manipulator and, at the same time, avoiding possible interference between the manipulator and the separator elements, also known as profiles.

Preferably, the suction cup circuit is mounted on said electromechanical arm.

In some embodiments, the article contained in the box is a sachet containing loose material, e.g. cereal.

It should be noted that some steps of the above-described process may be independent of the order of execution reported, unless it is expressly indicated that sequentiality or simultaneity between two or more steps is necessary. Furthermore, some steps can be optional. Furthermore, some steps of the process can be performed repetitively, or can be performed in series or in parallel with other steps of the process.

### BRIEF DESCRIPTION OF THE DRAWINGS

The characteristics and advantages of the invention will become clearer from the detailed description of a preferred embodiment thereof, shown by way of non-limiting example, with reference to the appended drawings, wherein:

FIG. 1 is a perspective view of an apparatus for moving packages with a box-like body provided with manipulators manufactured in accordance with the present solution;

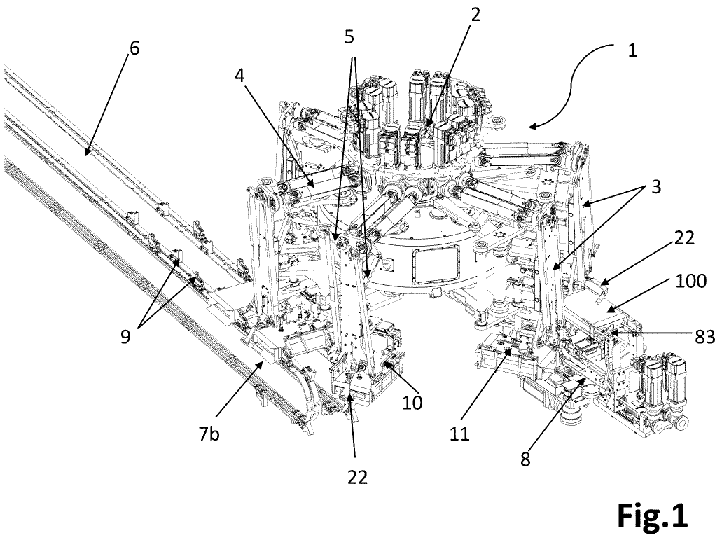

FIG. 2 is another perspective view of the apparatus of FIG. 1;

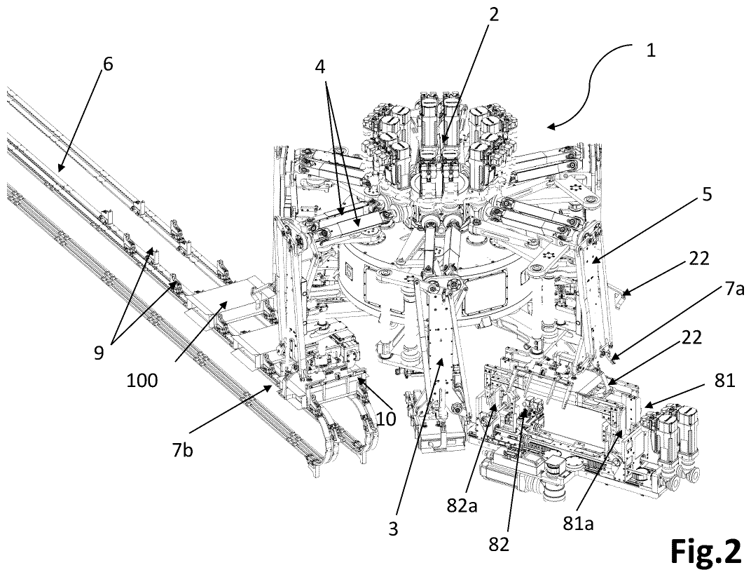

FIG. 3 is a radially external perspective view of the manipulator of FIG. 1 with the gripping elements and the containment element in an intermediate configuration between open configuration and gripping configuration around a box containing an article;

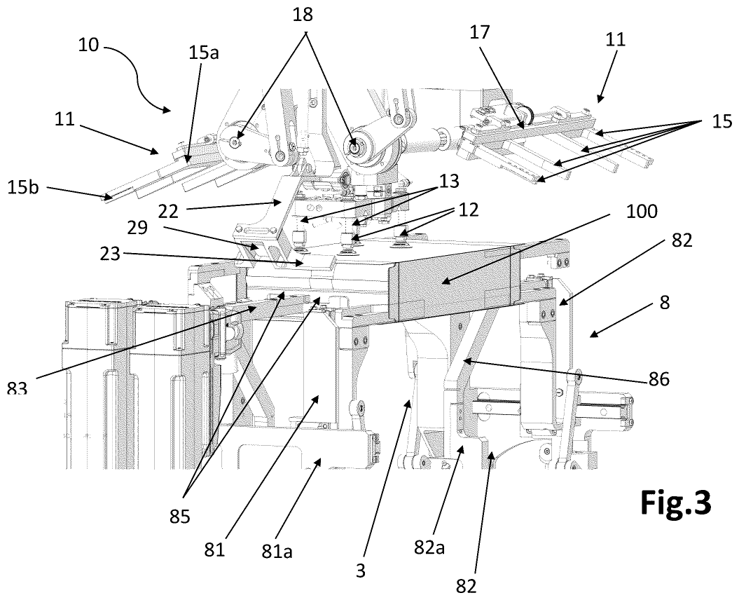

FIG. 4 is a radially external perspective view of the manipulator of FIG. 1 with the gripping elements in an intermediate configuration between open configuration and gripping configuration around a box containing an article;

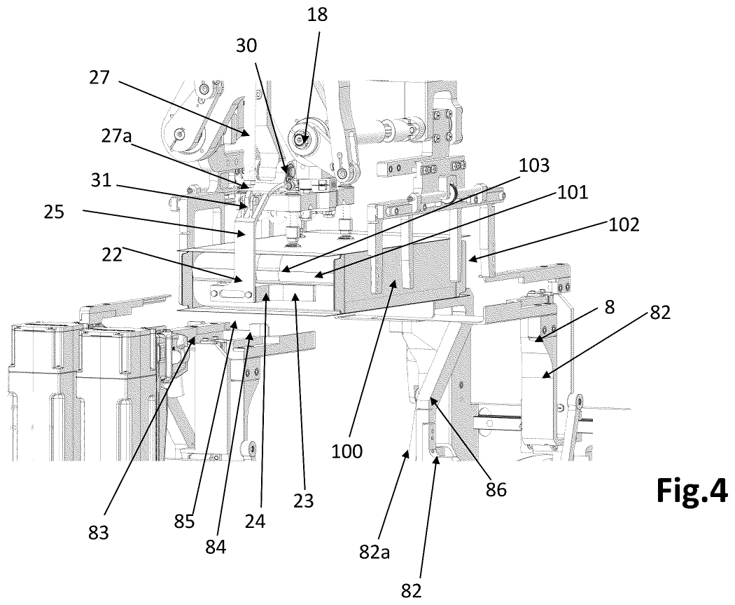

FIG. 5 is a radially external perspective view of the manipulator of FIG. 1 with the gripping elements and the containment element in a gripping configuration of a box containing an article from a mandrel;

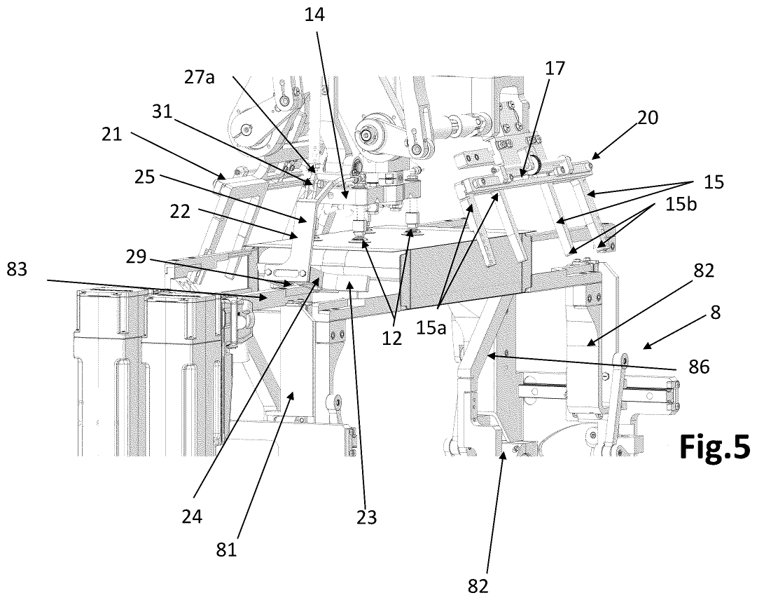

FIG. 6 is a radially internal perspective view of the manipulator of FIG. 1 with the gripping elements and the containment element in an intermediate configuration between open configuration and gripping configuration around a box containing an article;

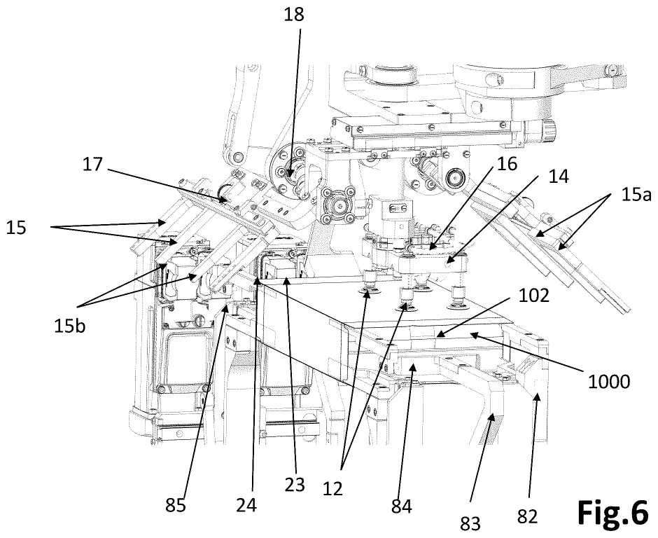

FIG. 7 is a sectional side view of the manipulator of FIG. 1 with the gripping and the containment element in an open configuration and a mandrel in an operating position;

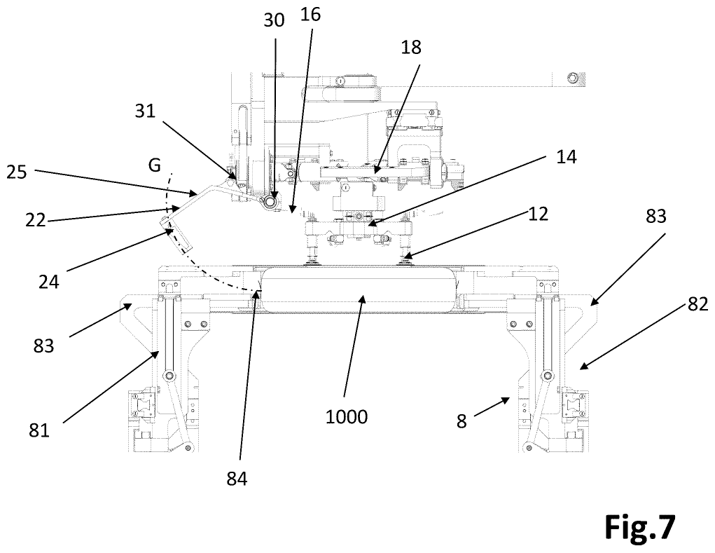

FIG. 8 is a sectional side view of the manipulator of FIG. 1 with the gripping elements and the containment element in a gripping configuration and a mandrel in a non-operating position;

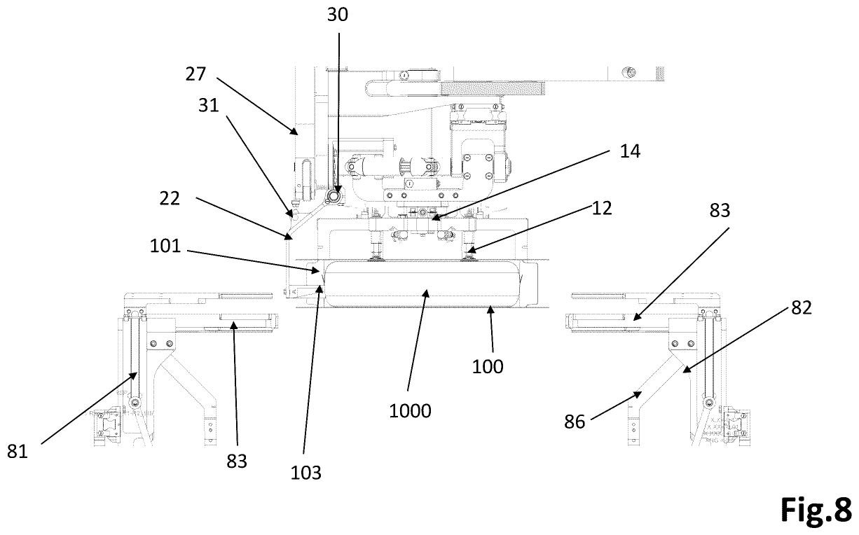

FIG. 9 is a perspective view of the manipulator and an electromechanical arm which moves it of FIG. 1 with the gripping elements and the containment element in an open configuration; and

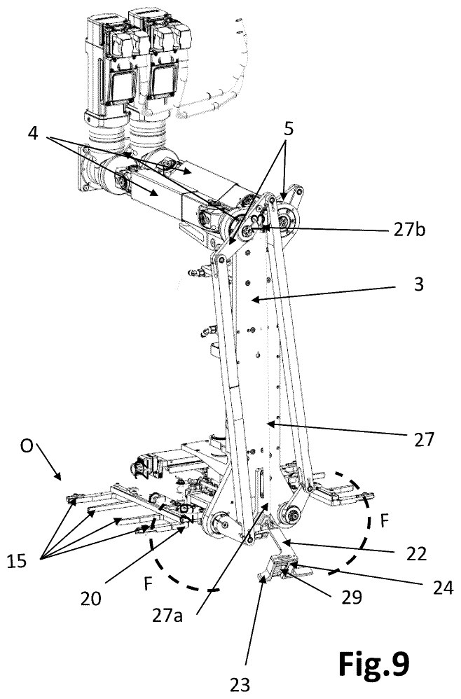

FIG. 10 is a perspective view of the manipulator and an electromechanical arm which moves it of FIG. 1 with the gripping elements and the containment element in a gripping configuration around a box containing articles.

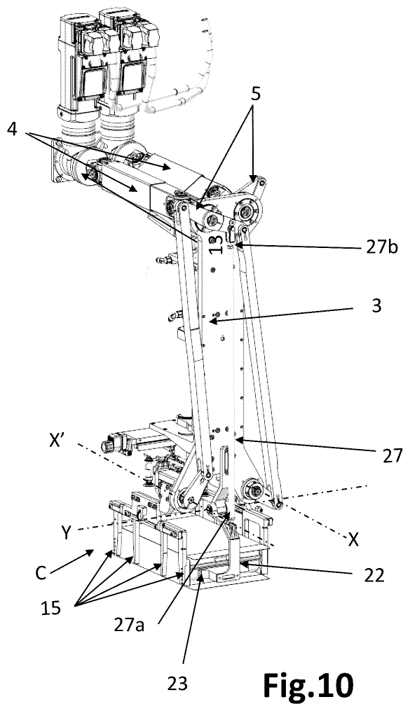

### DETAILED DESCRIPTION OF THE PREFERRED EMBODIMENTS

With reference to the appended figures, 1 overall indicates an apparatus for moving packages 100 with a box-like body, for the sake of simplicity also called only boxes 100, and the boxing of articles 1000 with variable geometry, manufactured in accordance with the present solution.

In the preferred case described herein the articles 1000 with variable geometry are sachets containing cereals which must be moved between a starting point 7a and an arrival point 7b.

For this purpose, the apparatus 1 comprises a first carousel 2, rotating about a vertical axis, on which a plurality of manipulators 10 are mounted through respective electromechanical arms 3.

Each arm 3 comprises a first end connected to the carousel 2 and a second end connected to the respective manipulator 10.

The electromechanical arms 3 have three degrees of freedom allowing the vertical, horizontal and rotational displacement of each manipulator 10. Each electromechanical arm 3 can assume different positions during each revolution of the carousel 2: a radial position with respect to the axis of rotation of said first carousel 2, or a position which deviates from the radial position by an angle comprised between −60° and +60°. Said position variation allows said arm 3 to vary its rotational speed during each revolution of the carousel 2.

Each arm 3 comprises an actuation mechanism 4 for each gripping element 11.

The actuation mechanism 4 in turn comprises a plurality of articulated levers 5 which allow the gripping elements 11 to pivot between an open configuration O and a gripping configuration C, and vice versa.

In the preferred case described herein, the apparatus 1 also comprises a conveyor belt 6 in which the manipulator 10 deposits the box 100. The conveyor belt 6 thus defines the arrival point 7b of the movement of the packages 100 by the manipulator 10.

The conveyor belt 6 in turn comprises separator elements 9, also known as profiles, arranged in steps along the conveyor belt 6, between which the boxes 100 are released.

Advantageously, the change in rotational speed allows the arm 3 to stay longer at the starting point 7a and the arrival point 7b in order to pick up and release the box 100 while minimizing impacts and damage to the articles 1000 contained in the package 100.

The variation in rotational speed also allows the manipulator 10 to couple with said separator elements 9 during the release of the box 100.

Each manipulator 10 is moved between the starting point 7a and the arrival point 7b along a path defined essentially by an arc of a circle, centered on the axis of rotation of the first carousel 2.

Each manipulator 10 comprises a pair of gripping elements 11 cooperating with each other to grasp a box 100 and a containment element 22 to hold an article 1000 inside the box 100, in particular along the circumferential arc. For this purpose, the gripping elements 11 are pivotable along a first movement trajectory F from the open configuration O to the gripping configuration C and vice versa, and the containment element 22 is pivotable along a second movement trajectory G.

In the preferred case shown in the figures, the containment element 22 comprises an abutment wall 23 extended parallel to the first movement trajectory F.

Furthermore, the containment element 22 comprises a connection element 25 which rotatingly connects it to the manipulator 10 through a first hinge 30.

The connection element 25 has an elbow configuration, and at the elbow has a second hinge 31 on which an actuating rod 27 of the containment element 22 is articulated.

The actuating rod 27 comprises a first end 27a thereof articulated to the connection element 25 and a second end 27b thereof articulated to one of the articulated levers 5 of the electromechanical arm 3.

Therefore, said actuating rod 27 is moved together with the gripping elements 11 and the containment element 22 is pivotably connected, by means of the actuating rod 27 to the articulated levers 5 of the electromechanical arms 3.

Thereby, the containment element 22, when the manipulator 10 is in the gripping configuration C, is positioned so as to keep the article 1000 inside the box 100, in particular when the latter is handled along a curvilinear section of a predefined movement path.

In the preferred case described herein, the boxes 100 have a box-like body extended longitudinally between a front end 101, radially external with respect to said curvilinear section, and a rear end 102, radially internal with respect to said curvilinear section, with an opening 103 at each of said front 101 and rear 102 ends.

The manipulator 10 further comprises a first end region 20, radially external with respect to the curvilinear section of the predefined path along which the box 100 is displaced by the manipulator 10, and a second end region 21, longitudinally opposite the first end region 20 and radially internal with respect to said curvilinear section.

With reference to the figures, said containment element 22 is configured so as to at least partially obstruct said radially external opening 103 when said gripping elements 11 grasp a respective box 100 to move it along said curvilinear section and so as to prevent said articles 1000 from escaping due to the action of the centrifugal force.

The manipulator 10 also comprises a plurality of adhesion elements 12, interposed between the gripping elements 11. Each adhesion element 12 is mounted on a respective elastic support 13.

In the preferred case described herein, the adhesion elements 12 are suction cups connected to a suction circuit 16 while the elastic supports 13 are springs.

The suction cups 12 and the respective springs 13 are mounted on a plate 14 with an adjustable position with respect to the gripping elements 11.

The plate 14 is rectangular in shape and there are four suction cups 12 and the respective springs 13, which are arranged symmetrically on the plate 14, in particular they are equidistant from the axes of symmetry of the plate 14.

The manipulator 10 also comprises a main body 17 to which the rotational actuators 18 of the gripping elements 11 are rotatably connected.

Each of said gripping elements 11 comprises four prongs 15, extending from the main body 17, substantially perpendicular to the movement trajectory F of the gripping elements 11.

The prongs 15 comprise an attachment end 15a, proximal to the main body 17 and a free end 15b, distal with respect to the main body 17.

The prongs 15 are advantageously movable two by two along the respective main body 17 so as to longitudinally distance or approach the first end region 20 and the second end region 21 along the longitudinal direction of the gripping element 11.

Said gripping elements 11 of the manipulator 10 are shaped so as not to interfere with the separator elements 9.

The plate 14 to which the suction cups 12 with the respective springs 13 are connected is vertically slidable by means of a vertical actuator mounted on the electromechanical arm 3.

The suction circuit 16 of the suction cups 12 comprises a pump and a control unit installed on said arm 3.

In the preferred case described herein, the apparatus 1 also comprises a second carousel on which at least one mandrel 8 is mounted, which arrives near the first carousel 2 and from which the manipulator 10 picks up a box 100 at a point in the trajectory of the mandrel 8 which defines the starting point 7a of the movement of the boxes 100 by means of the manipulator 10.

The mandrel 8 moves along a curvilinear trajectory.

With reference to the figures, the mandrel 8 is arranged to receive the articles 1000 from an article feeder and form a box 2 around them from starting from a blank provided by a blank feeder.

In the preferred case described herein, the mandrel 8 comprises a first unit 81 and a second unit 82, separate and distinct from each other, both mounted on a lower arm radially extended from the second carousel and passing below a work plane of the mandrel 8, fixed to the ground and extended along the circular path on which the mandrels 8 are conducted.

In particular, the first unit 81 and the second unit 82 are mounted on the lower arm by means of a respective upright 81a, 82a erected from the lower arm so as to support the units 81 and 82 above the level defined thereby.

The first unit 81 is therefore in a radially internal position with respect to the axis of rotation of the second carousel, while the second unit 82 is in a radially external position with respect to the axis of rotation of the second carousel.

The first unit 81 and the second unit 82 are substantially identical to each other and are arranged facing each other.

Each mandrel 8 further comprises a movement system configured to displace the first unit 81 and the second unit 82 with respect to each other between an operating position, in which the two units 81, 82 are brought closer to each other so as to compose said mandrel 8, and a non-operating position in which the two units 81, 82 are moved away from each other, so as to decompose the mandrel 8.

In particular, the two units 81 and 82 are moved between the operating position and the non-operating position by sliding along the lower arm, and are therefore approached and distanced along a substantially radial separation direction with respect to the second carousel 8.

Each unit 81, 82 comprises a positioning element 83 arranged to retain the article 1000 inside the box 100 when the first and the second unit 81, 82 are extracted from the box 100.

The positioning element 82 is movable with respect to the respective first or second unit 81, 82 and is moved so that the containment element 22 takes over said positioning element 83, without coming into contact with each other, when said manipulator 10 is arranged in the gripping configuration C and the mandrel 8 is in the non-operating configuration.

The containment element 22 and the positioning element 83 are mutually configured to allow the containment element 22 to arrange itself inside the box 100 before the positioning element 83 has exited the box.

In fact, the containment element 22 comprises a first recess 29 extending from the abutment wall 23 to an attachment body 24 thereof, to allow the containment element 22 to pivot without interfering with the positioning element 83.

Similarly, the positioning element 83 which is radially internal with respect to the axis of rotation of the second carousel comprises a front element 84 comprising a second recess 85 and a connection rod 86 connecting the front element 84 to each respective unit 81, 82.

Said first 29 and second 85 recess are positioned in a complementary manner, the first recess 29 being at the solid parts of the front element 84, the second recess 85 being at the solid parts of the abutment wall 23, so as to avoid collisions between the containment element 22 and the positioning element 83 during the production process.

In the preferred case described herein, the positioning element 83 which is radially external with respect to the axis of rotation of the second carousel has a frontal element 84 without recesses.

To move the boxes 100, the manipulator 10, with the gripping elements 11 in the open configuration O, is brought by the first carousel 2 close to the starting point 7a, viz., at a mandrel 8 containing the article 1000 to be packaged and around which the box-like body of the box 100 has been formed.

At this point, the box 100 contained in the mandrel 8 is grasped by means of the manipulator 10 moving the gripping elements 11 along the first movement trajectory F from the open configuration O to the gripping configuration C. During this movement, the containment element 22 at least partially obstructs said opening 103 of the radially external front end 101.

Thereby, the centrifugal force is counteracted and the article 1000 contained in the box 100 is prevented from escaping through the opening 103 and, in particular, through the opening 103 of the front end 101 of the box 100 which is in a radially external position with respect to the rotational movement of the manipulator 10.

At the same time, the suction cups 12 are activated, so that the package 100 is further retained from above.

The box 100 is then displaced from the mandrel 8 to the conveyor belt 6, moving the manipulator 10 along the curvilinear path defined by the rotation of the first carousel 2. It will be noted that the article 1000 contained in the package 100, although pushed outwards by the centrifugal force due to the curvilinear path of the manipulator 10, is retained inside the package 100 by the presence of the containment element 22.

Upon reaching the arrival point 7b, at the conveyor belt 6, the manipulator 10 releases the box 100, deactivating the suction cups 12 and displacing the gripping elements to the open configuration O.

In particular, the release of the box 100 takes place between two rows of separator elements 9, so that the square shape of the box 100 imposed by the manipulator 10 is also maintained in the subsequent displacement along the conveyor belt 6.

The present solution thus makes it possible to solve the technical problem identified above, while at the same time achieving further advantages, including the possibility of easily adjusting one or more dimensions of the manipulator 10 according to the dimensions of the box 100 to be moved.

It goes without saying that, in order to meet specific and contingent application needs, a person skilled in the art will be able to make further modifications and variants to the solution described above that are nevertheless within the scope of protection as defined by the following claims.

1. A manipulator of articles in boxes, wherein the manipulator movable along a predefined path comprising at least one curvilinear section, the boxes comprise a box-like body that extends longitudinally between a front end, radially external with respect to said curvilinear section, and a rear end, radially internal with respect to said curvilinear section, said box-like body has an opening at least at said front end, said manipulator comprises a pair of gripping elements that can cooperate with each other for grasping one of said boxes and a containment element in a radially external position with respect to said curvilinear section, wherein the manipulator is movable from an open configuration to a gripping configuration and vice versa, wherein the gripping elements and the containment element are pivotable respectively along a first movement trajectory and a second movement trajectory between said open configuration and said gripping configuration and vice versa, and wherein the containment element is configured so as to obstruct, at least partially, said opening when the gripping elements grasp a respective box to move it along said curvilinear section, and so as to prevent said articles from escaping.

2. The manipulator according to claim 1, wherein said gripping elements pivot about first axes of rotation parallel to each other and wherein said containment element pivots about a second axis of rotation that is substantially perpendicular to said first axes of rotation.

3. The manipulator according to claim 1, wherein a plurality of adhesion elements is interposed between said gripping elements.

4. The manipulator according to claim 3, wherein said adhesion elements comprise suction cups.

5. An apparatus for packaging articles in boxes, wherein said apparatus comprises:
a manipulator for boxes according to claim 1;
a mandrel configured to accommodate inside itself one of said articles around which a box is arranged;
wherein said apparatus is configured in such a way that said manipulator is arranged to take said box from said mandrel and move said box along a predefined path that comprises at least one curvilinear section; and wherein the containment element is configured to partially enter said box to retain said article when the manipulator moves the box along said curvilinear section.

6. The apparatus according to claim 5, wherein said mandrel comprises at least one respective positioning element arranged to retain the article inside the box when said article and said box are arranged on said mandrel, and wherein said containment element is configured to take over said positioning element in retaining said article in place along said predefined path.

7. The apparatus according to claim 5 further comprising a carousel that can rotate about a vertical axis, wherein a plurality of manipulators are mounted on said carousel via respective electromechanical arms, wherein each arm comprises a first end connected to the carousel and a second end connected to the manipulator.

8. The apparatus according to claim 7 wherein said arm comprises an actuation mechanism for each gripping element, and wherein the actuation mechanism comprises a plurality of articulated levers which allow the pivoting of the gripping elements between said open configuration and said gripping configuration and vice versa, and wherein said containment element is pivotably connected via an actuating rod to one of said articulated levers.

9. Process A process for moving articles in boxes along a predefined path that comprises at least one curvilinear section, wherein said boxes have a box-like body that extends longitudinally between a front end and a rear end, and said box-like body has an opening at least at one of said ends radially external with respect to said curvilinear section, the process comprising:
providing a manipulator on which a pair of gripping elements and a containment element in an open configuration are mounted;
grasping one of said boxes by means of said manipulator making the gripping elements pivot in a gripping configuration;
at least partially obstructing said opening with the containment element so as to contain said article inside the box at least in said curvilinear section by making the containment element pivot in a gripping configuration;
moving said box by displacing said manipulator along said predefined path; and
releasing said box.

10. The process according to claim 9, further comprising before said grasping:
releasing at least one article inside a mandrel;
arranging a box at least partially closed around said article released in said mandrel;
leaving said article positioned inside said box;
arranging said manipulator with said pair of gripping elements and said containment element in the open configuration.

11. The process according to claim 10, wherein after having arranged a box at least partially closed around said article released in said mandrel, at least one positioning element movably connected to said mandrel is arranged to keep said article positioned inside said box and the containment element shall take over said positioning element to at least partially obstruct said opening.

12. The process according to claim 9, wherein while said gripping elements are displaced in said gripping configuration, said containment element at least partially obstructs said opening.

13. The process according to claim 9, wherein said box is moved by said manipulator substantially within a geometric plane.

14. The process according to claim 13, wherein said geometric plane is a horizontal geometric plane.

15. The process according to claim 9, wherein said box is released by displacing said gripping elements in said open configuration.

16. The process according to claim 9, wherein said box is released by said manipulator with a predefined conformation on a conveyor belt that comprises separator elements, wherein said separator elements are provided to maintain said box in said predefined conformation.

17. The process according to claim 16, wherein said gripping elements are shaped so as not to interfere with said separator elements of said conveyor belt.
